(19) United States
(12) Patent Application Publication
(10) Pub. No.: US 2015/0138420 A1
(43) Pub. Date: May 21, 2015

(54) LIQUID CRYSTAL CELL CONNECTION TO LENS MOUNT OF CAMERA MODULE

(71) Applicant: STMicroelectronics Pte Ltd., Singapore (SG)

(72) Inventors: Hk Looi, Singapore (SG); David Gani, Choa Chu kang (SG); Wee Chin Judy Lim, Singapore (SG); Bs Aw, Singapore (SG); Cheng-Hai Cheh, Singapore (SG)

(73) Assignee: STMicroelectronics Pte Ltd., Singapore (SG)

(21) Appl. No.: 14/086,507

(22) Filed: Nov. 21, 2013

(51) Int. Cl. H04N 5/225; G02F 1/1341; G02F 1/1345; G02F 1/1333; G02F 1/1343

(52) U.S. Cl. CPC H04N 5/2257; G02F 1/133308; G02F 1/134309; G02F 1/1345; G02F 1/1341; H04N 5/2254; G02F 2001/133325; G02F 2001/133317
USPC 348/335; 349/58; 29/825

(57) ABSTRACT

Electronics modules and methods of making electronics modules are provided. An electronics module includes a substrate having an electronic circuit mounted thereon, a lens mount affixed to the substrate, the lens mount having a lens assembly mounted therein, and a liquid crystal cell affixed to the lens mount over the lens assembly, the liquid crystal cell having electrical terminals, wherein the lens mount includes adhesive containment pockets that are filled with a conductive adhesive so as to contact the electrical terminals of the liquid crystal cell, wherein the adhesive containment pockets include contacts that are electrically connected to the substrate. In some embodiments, the electronics module is a camera module.

### BACKGROUND

1. Technical Field

This disclosure relates to electronics modules and to methods of making electronics modules. More particularly, the disclosure relates to miniaturized camera modules and to methods of making miniaturized camera modules.

2. Discussion of the Related Art

Miniaturized camera modules are widely used in mobile devices such as mobile phones, tablet devices, and the like. Basic components of a miniaturized camera module include an image sensor chip and a lens mounted in a suitable housing. Requirements of such camera modules include small size, high performance and low cost.

Conventional miniaturized camera modules have fixed lens assemblies and do not provide focus and zoom functionality. The complex mechanical lens configurations of larger cameras are not compatible with miniaturized camera modules. It has therefore been proposed to use liquid crystal cells in miniaturized camera modules to provide focus and zoom capability. Such camera modules include a fixed lens and a liquid crystal cell mounted in front of the fixed lens. This configuration provides electronic control of focus and zoom functions.

### SUMMARY

The liquid crystal cell used in a miniaturized camera module may include several glass layers and a ring of liquid crystal material sandwiched between the glass layers. The liquid crystal ring is connected to electrical terminals at the edges of the liquid crystal cell. In order to operate the liquid crystal cell, the terminals at the edges of the liquid crystal cell are electrically connected to circuitry on the substrate of the camera module. The circuitry on the substrate provides operating voltages and control signals to the liquid crystal cell.

Accordingly, electrical connections are provided between the terminals at the edges of the liquid crystal cell and the substrate. The electrical connections must have high reliability and must be compatible with automated manufacturing techniques.

According to one embodiment, an electronics module comprises a substrate having an electronic circuit mounted thereon, a lens mount affixed to the substrate, the lens mount having a lens assembly mounted therein, and a liquid crystal cell affixed to the lens mount over the lens assembly, the liquid crystal cell having electrical terminals, wherein the lens mount includes adhesive containment pockets that are filled with a conductive adhesive so as to contact the electrical terminals of the liquid crystal cell, wherein the adhesive containment pockets include contacts that are electrically connected to the substrate.

In some embodiments, the conductive adhesive fills the adhesive containment pockets to a level below a top surface of the liquid crystal cell.

In some embodiments, the liquid crystal cell comprises two or more glass layers, the electrical terminals of the liquid crystal cell comprise conductive strips between the glass layers, and the conductive adhesive contacts conductive strips of the liquid crystal cell.

In some embodiments, the liquid crystal cell includes at least two conductive strips associated with each electrical terminal and the adhesive containment pockets have sufficient depth to contact each of the conductive strips.

In some embodiments, each adhesive containment pocket comprises a recess in the lens mount and an electrical contact in the recess.

In some embodiments, the electrical terminals of the liquid crystal cell are located along edges of the liquid crystal cell in alignment with respective adhesive containment pockets.

In some embodiments, the electrical connections between the adhesive containment pockets and the substrate are recessed in the lens mount.

In some embodiments, the electronic circuit comprises an image sensor and the electronics module comprises a camera module.

According to another embodiment, a method for making an electronics module comprises providing an electronics subassembly including a substrate having an electronic circuit mounted thereon and a lens mount affixed to the substrate, the lens mount having a lens assembly mounted therein and being provided with adhesive containment pockets, attaching a liquid crystal cell to the lens mount over the lens assembly, and filling the adhesive containment pockets with a conductive adhesive so as to contact the electrical terminals of the liquid crystal cell, wherein the adhesive containment pockets include contacts that are electrically connected to the substrate.

### BRIEF DESCRIPTION OF THE DRAWINGS

For a better understanding of the embodiments, reference is made to the accompanying drawings, which are incorporated herein by reference and in which:

FIG. 1 is a perspective view of a camera module with the baffle removed, in accordance with embodiments;

FIG. 2 is a top view of the camera module of FIG. 1;

FIG. 3 is a cross-sectional view of the camera module of FIG. 1;

FIG. 4 is an exploded view of the camera module of FIG. 1, including the baffle;

FIG. 5 is a perspective view of a liquid crystal cell used in the camera module of FIG. 1, in accordance with embodiments;

FIG. 6 shows details of an electrical terminal of the liquid crystal cell of FIG. 5;

FIG. 7 shows details of an adhesive containment pocket, in accordance with embodiments;

FIG. 8 is a perspective view of a camera module with the baffle removed, in accordance with additional embodiments;

FIG. 9 is a flow chart of a process for manufacturing a camera module, in accordance with embodiments;

FIGS. 10A-10E illustrate the camera module during different phases of manufacturing, in accordance with embodiments.

### DETAILED DESCRIPTION

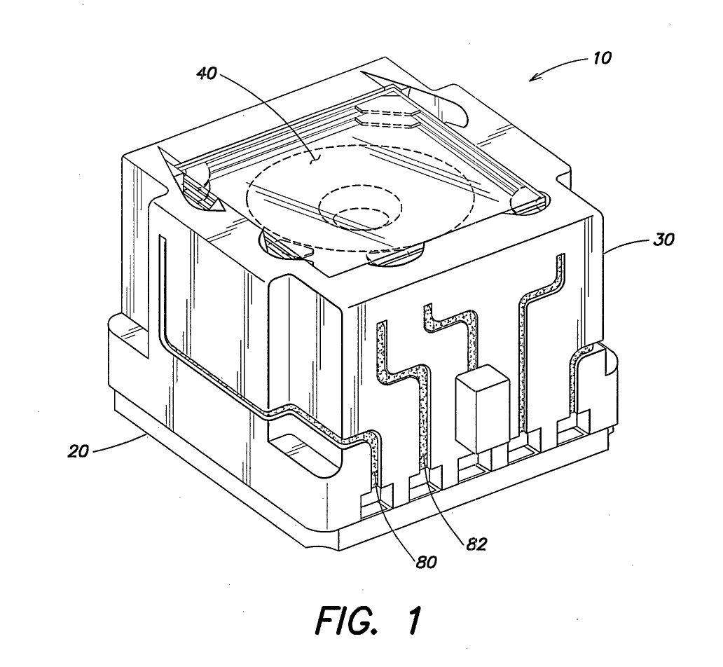

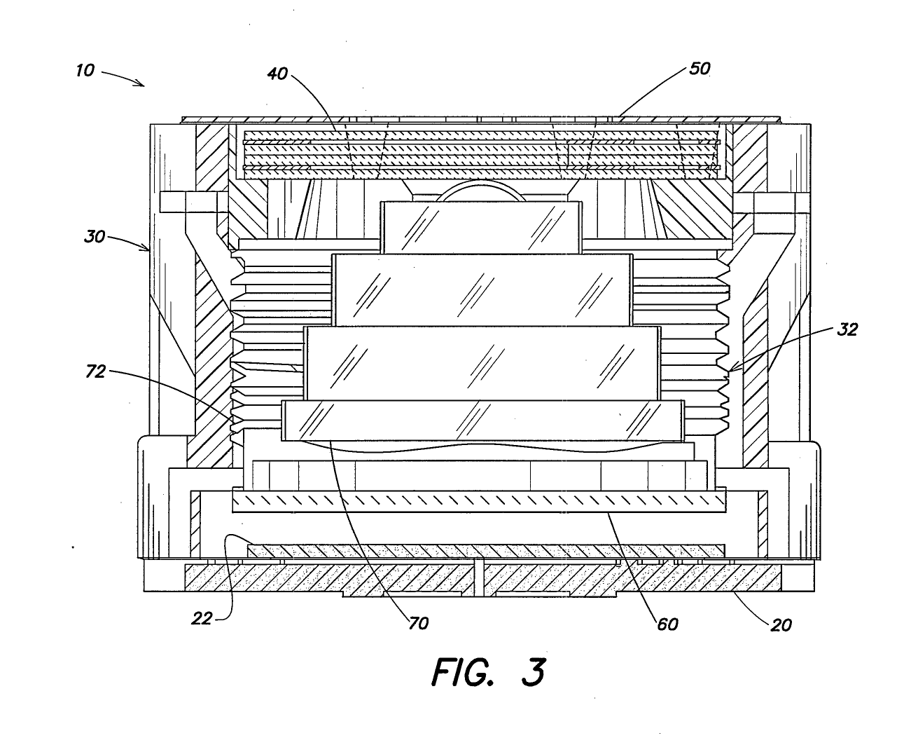

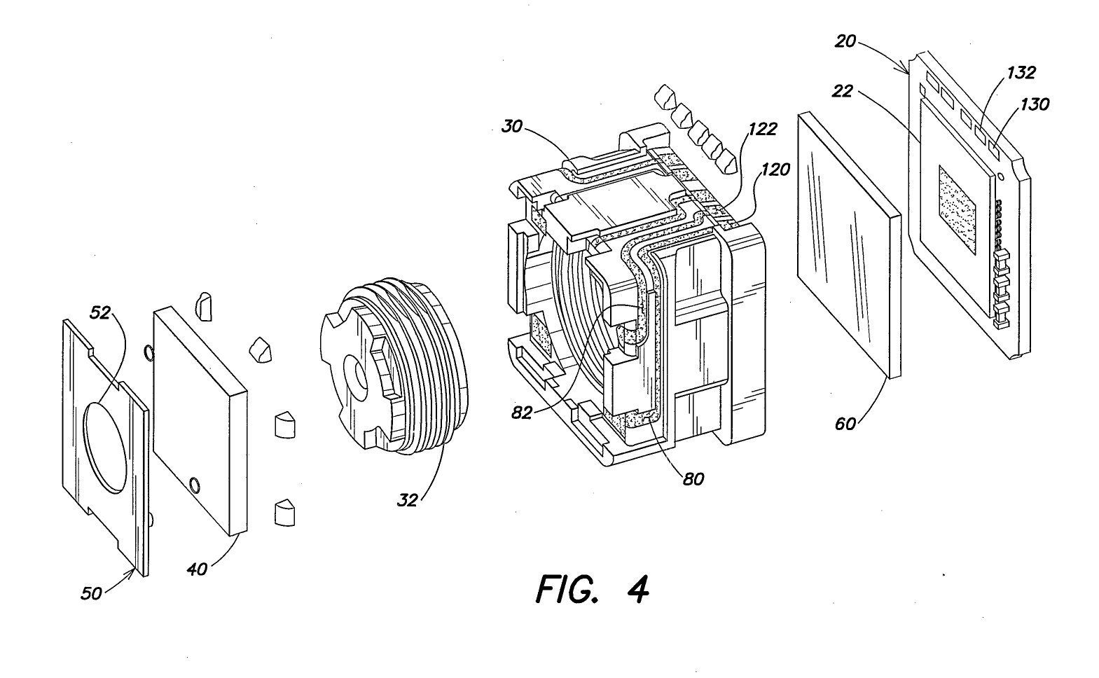

An electronics module in the form of a camera module 10 in accordance with embodiments is shown in FIGS. 1-4. The camera module 10 includes a substrate 20 on which is mounted an electric chip or die, such as an image sensor chip 22. Additional electronic components may be mounted on substrate 20. A lens mount 30 is affixed to substrate 20 and serves as a housing or support for elements of the camera module 10. A lens assembly 32 is positioned in lens mount 30 in alignment with an optical axis of image sensor chip 22. A liquid crystal cell 40 is affixed to the top of lens assembly 32, and a baffle 50 (FIGS. 3 and 4) having an opening 52 covers liquid crystal cell 40. An infrared glass layer 60 is positioned between image sensor chip 22 and lens assembly 32.

The lens assembly 32 includes a lens 70 and a lens barrel 72. The lens 70 is mounted in a fixed position in lens barrel 72. The lens barrel 72 has a generally cylindrical configuration and is threaded on its outer surface for engagement with corresponding threads in lens mount 30. By rotation of the threaded lens barrel 72 in the lens mount 40, the focus of the camera module can be adjusted during the manufacturing process.

The lens mount 30 may be a molded housing member that supports the lens assembly 32, the liquid crystal cell 40, the baffle 50 and the infrared glass layer 60 in the camera module. By way of example only, the lens mount 30 may be about 6.5 mm square. The lens mount 30 is affixed at its lower end to substrate 20. The lens mount 30 includes electrical conductors 80, 82, etc. that provide electrical connections between liquid crystal cell 40 and substrate 20. In the embodiment of FIGS. 1-4, the lens mount 30 includes five electrical conductors that provide connections between the liquid crystal cell 40 and the substrate 20. It will be understood that different numbers and locations of electrical conductors may be provided depending on the configuration of liquid crystal cell 40.

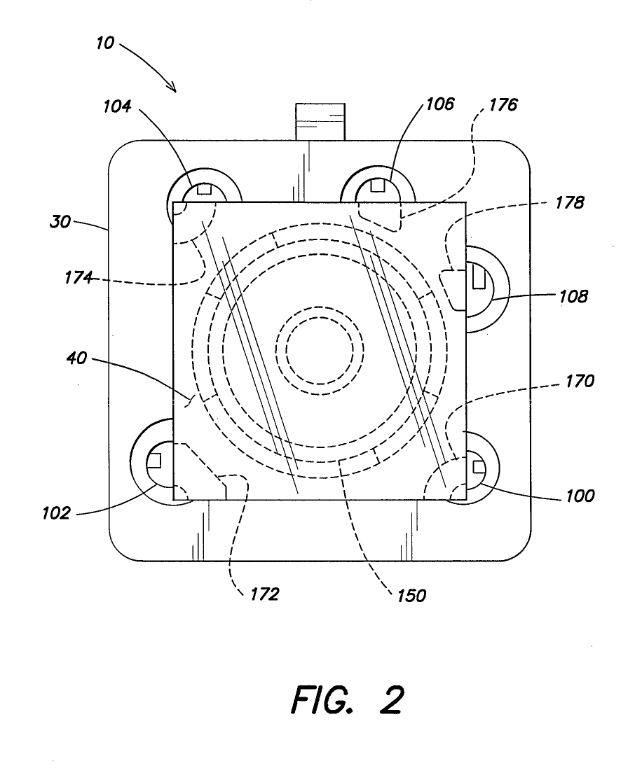

Lens mount 30 further includes adhesive containment pockets 100, 102, 104, 106 and 108 on its upper surface, as best shown in FIG. 2. The adhesive containment pockets may be formed during the molding of lens mount 30 and facilitate electrical connections to electrical terminals of liquid crystal cell 40 as described below. The electrical conductors 80, 82, etc. provide electrical connections between respective adhesive containment pockets 100, 102, 104, 106 and 108 and terminals 120, 122, etc. (FIG. 4) at the lower end of lens mount 30. The terminals 120, 122, etc. are electrically connected to corresponding terminals 130, 132, etc. on substrate 20, so that the liquid crystal cell 40 can be controlled by the circuitry on substrate 20.

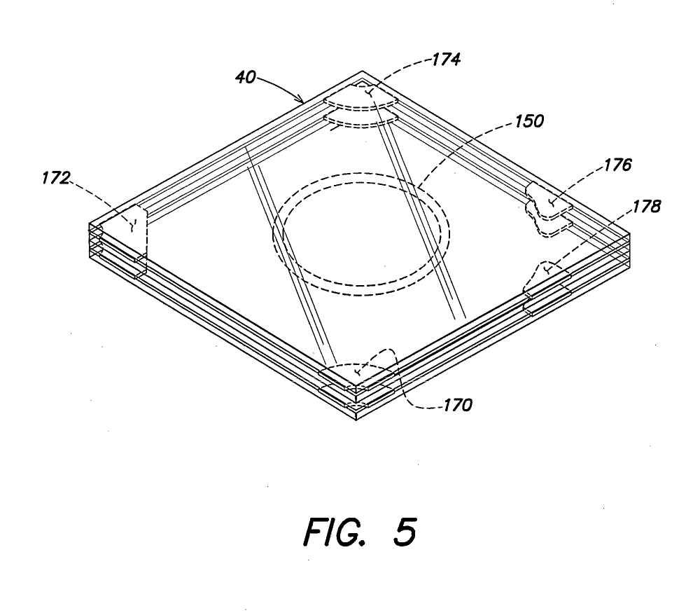

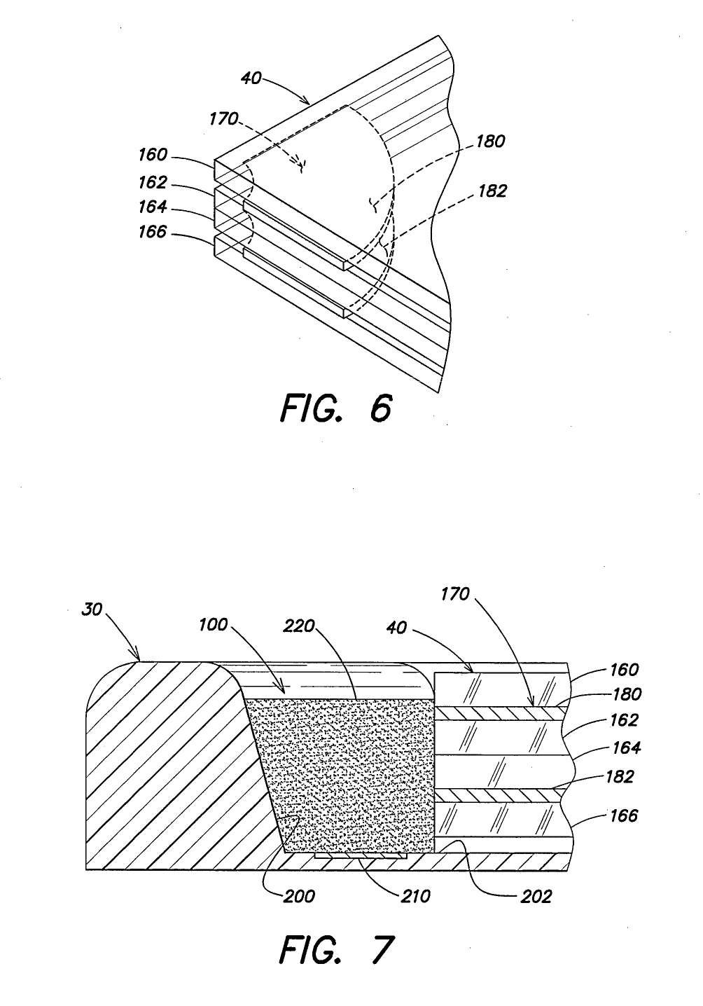

A perspective view of liquid crystal cell 40 is shown in FIG. 5, and details of one of the terminals of the liquid crystal cell 40 are shown in FIG. 6. In embodiments, the liquid crystal cell 40 includes a ring 150 of liquid crystal material that is centered on the optical axis of the camera module 10. The ring 150 of the liquid crystal material is sandwiched between several glass layers. In the embodiment of FIGS. 5 and 6, liquid crystal cell 40 includes glass layers 160, 162, 164 and 166.

The liquid crystal cell 40 further includes electrical terminals at its outer edge for supplying operating power and control signals to liquid crystal ring 150. In the embodiment of FIGS. 5 and 6, the liquid crystal cell 40 includes electrical terminals 170, 172, 174, 176 and 178, which are electrically connected to ring 150 by conductors (not shown) between the glass layers. As shown in FIG. 5, the electrical terminals of liquid crystal cell 40 may be located at the corners of the glass layers or along the side edges of the glass layers. By application of suitable operating voltages and control signals to liquid crystal cell 40, the liquid crystal cell 40 performs focus and zoom functions of the camera module.

As shown in FIG. 6, the electrical terminals of the liquid crystal cell 40 may be in the form of one or more conductive layers between glass layers 160, 162, 164 and 166. In the embodiment of FIG. 6, electrical terminal 170 includes a first conductive layer 180 between glass layers 160 and 162, and a second conductive layer 182 between glass layers 164 and 166. In some embodiments, the conductive layers 180 and 182 may be a conductive paste, such as a silver paste.

An enlarged cross-sectional view of adhesive containment pocket 100 is shown in FIG. 7. As shown, adhesive containment pocket 100 is formed as a recess in lens mount 30 located adjacent to electrical terminal 170 of liquid crystal cell 40. The adhesive containment pocket 100 maybe defined by a sidewall 200 and a bottom wall 202 and may have a semicircular cross section in a horizontal plane, as shown in FIG. 2. The sidewall 200 of adhesive containment pocket 100 may have a sloped configuration, as shown in FIG. 7. In particular, the adhesive containment pockets may have a truncated conical shape (FIG. 3). An electrical contact 210, typically at the bottom of the adhesive containment pocket 100, provides an electrical connection to the substrate 20. The electrical contact 210 may, for example, be gold plating on the adhesive containment pocket or a conductive pin. The adhesive containment pocket 100 has sufficient depth to provide access to the conductive layers 180 and 182 of liquid crystal cell 40.

As further shown in FIG. 7, the adhesive containment pocket 100 is filled with a conductive adhesive 220 so as to make electrical contact with conductive layers 180 and 182 of liquid crystal cell 40. The conductive adhesive 220 may be of high conductivity and low resistivity. In some embodiments, adhesive containment pocket 100 may be filled with conductive adhesive 220 to a level above the top conductive layer 180 but below a top surface of the liquid crystal cell 40. By controlling the fill level in this manner, the conductive adhesive 220 does not contact the baffle 50 which is mounted over the liquid crystal cell in the camera module. It will be understood that the adhesive containment pocket 100 may have different sizes and shapes provided that the conductive adhesive which fills or partially fills the adhesive containment pocket makes electrical contact with each conductive layer 180, 182 of electrical terminal 170. By way of example only, the adhesive containment pockets may have a depth on the order of 0.7 mm and a diameter on the order of 0.3 mm.

As best shown in FIG. 2, the lens mount 30 is provided with adhesive containment pockets 100, 102, 104, 106 and 108 which are positioned to enable electrical contact between the conductive adhesive 220 and electrical terminals 170, 172, 174, 176 and 178, respectively, of liquid crystal cell 40. It will be understood that the liquid crystal cell 40 may have different numbers and locations of electrical terminals. In such cases, the number and positions of the adhesive containment pockets are selected to enable electrical contact with each of the electrical terminals of the liquid crystal cell 40.

In the embodiments of the FIGS. 1-4, the lens mount 30 may be formed by laser direct structuring (LDS). In this process the lens mount is injection molded using a thermoplastic material doped with a metal-plastic additive activated by a laser. After molding, a laser writes the circuit trace on the plastic. Where the laser beam hits the plastic, the metal additive forms a circuit trace.

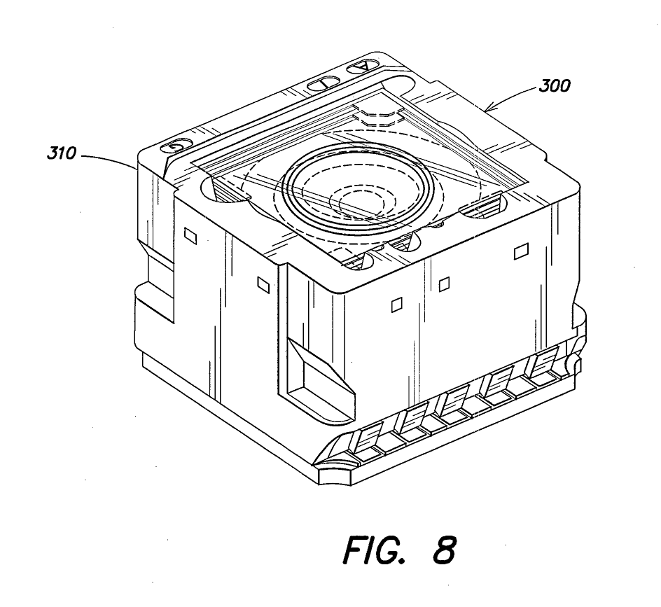

A camera module 300 including an insert molded lens mount 310 in accordance with additional embodiments, is shown in FIG. 8. In the insert molded lens mount 310, contact pins are embedded in the molded lens mount with contact surfaces placed at the bottom of the adhesive containment pockets. The contact pins are of etched metal that is formed to fit the required profile. The components of the camera module 300 are otherwise similar to the components of the camera module 10 shown in FIGS. 1-4 and described above.

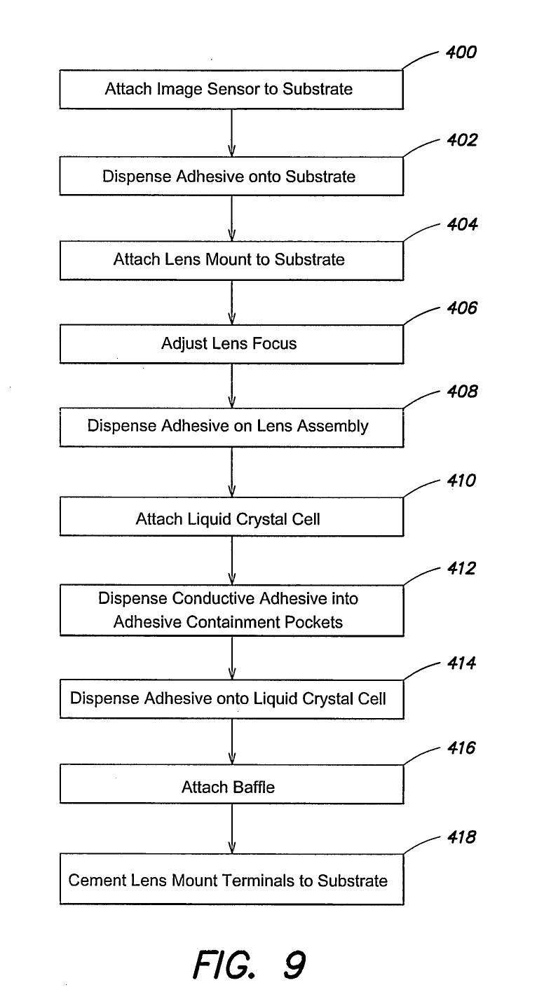

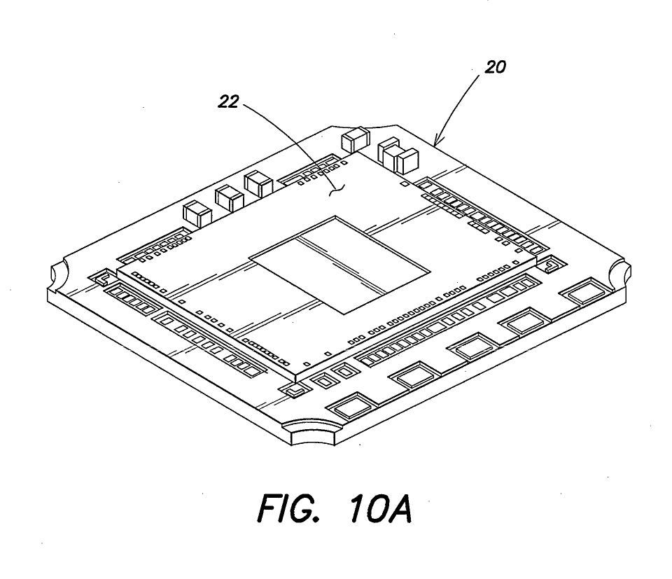

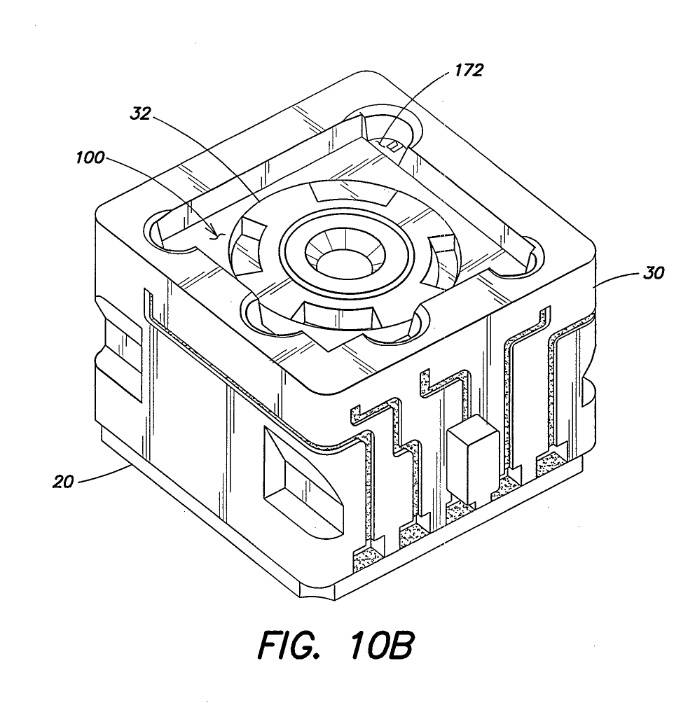

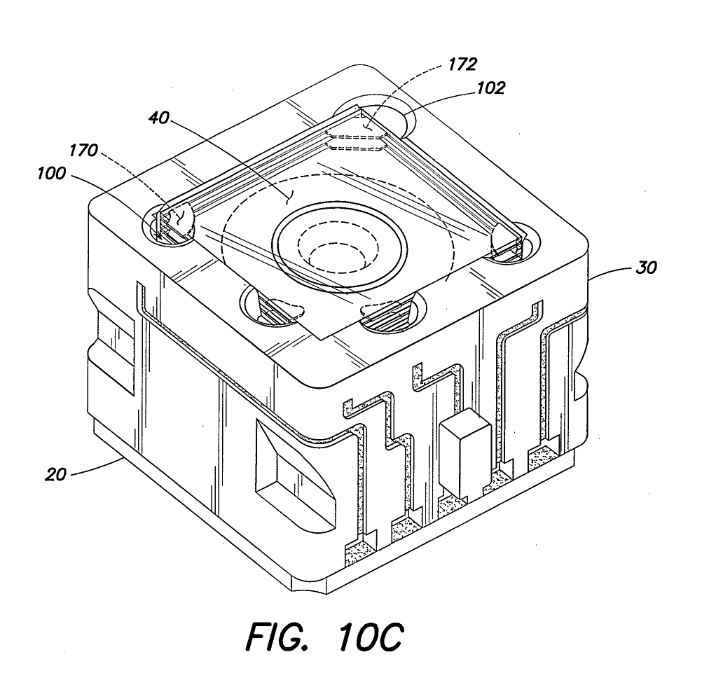

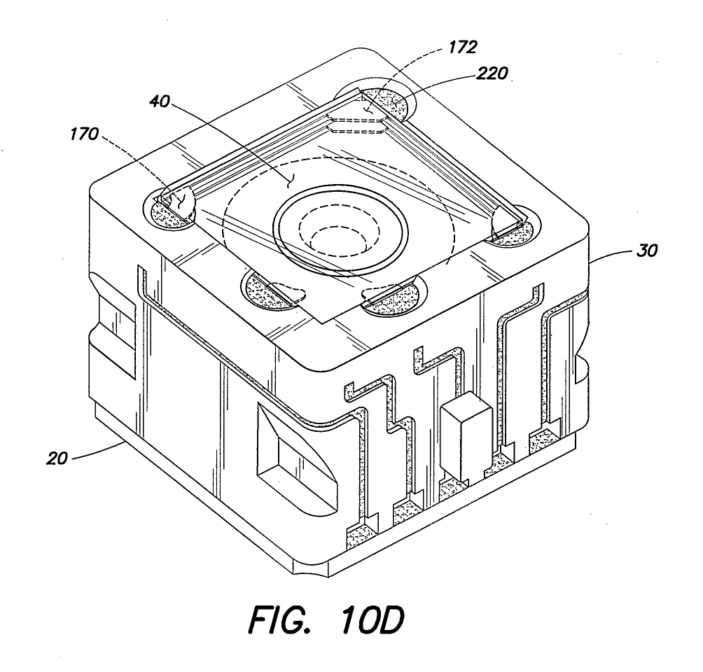

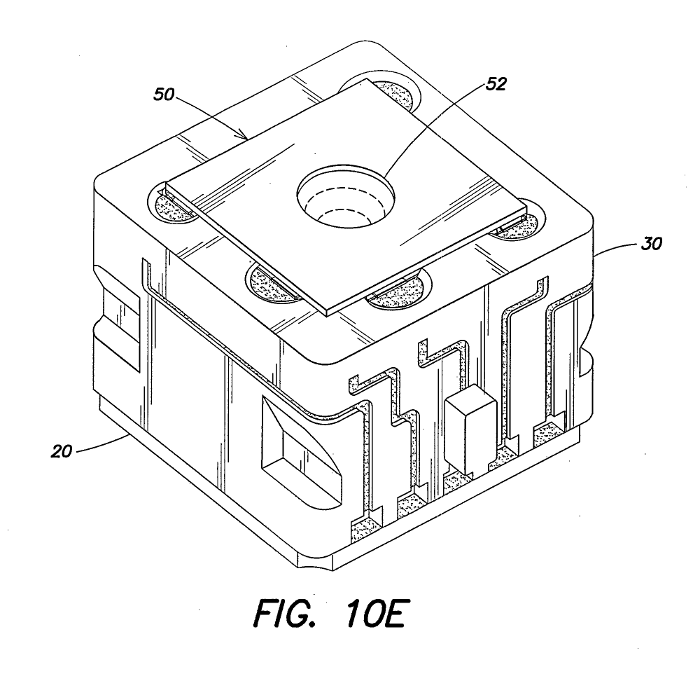

A flow chart of a process, in accordance with embodiments, for manufacturing the camera modules described herein is shown in FIG. 9. The camera module is shown in various phases of the manufacturing process in FIGS. 10A-10E. It will be understood that the process may include additional acts and that some of the acts described herein may be optional.

Referring to FIG. 9, the image sensor chip 22 and other electronic components are attached to substrate 20 in act 400. The substrate 20 with image sensor chip 22 and other components attached is shown in FIG. 10A. In act 402, a non-conductive adhesive is dispensed onto the periphery of the substrate, and the lens mount 30 is attached to the substrate in act 404. The non-conductive adhesive, after curing, attaches the lens mount 30 to the substrate 20. The substrate 20 with the lens mount 30 attached to substrate 20 is shown in FIG. 10B.

The lens mount 30 contains the lens assembly 32 when it is attached to substrate 20. In act 406, the lens assembly is adjusted for best focus, by rotating the lens assembly 32 in the threaded lens mount 30, and the lens assembly is fixed in position, typically with an adhesive, after focusing.

In act 408, an adhesive is dispensed or stamped onto the lens barrel 72 of the lens assembly 32, and the liquid crystal cell 40 is attached to the lens assembly within the lens mount 30 in act 410, as shown in FIG. 10C. In attaching the liquid crystal cell 40 to the lens assembly 32, the liquid crystal cell 40 is oriented such that its electrical terminals correspond in position to respective adhesive containment pockets of the lens mount 30.

In act 412, a conductive adhesive is dispensed into the adhesive containment pockets 100, 102, 104, 106 and 108 (FIG. 2), so as to establish electrical connections to the electrical terminals of the liquid crystal cell 40. As described above, the adhesive containment pockets may be filled to a level that covers each conductive layer 180, 182 of electrical terminal 170 but which is slightly below the top surface of the liquid crystal cell 40. The dispensing of the conductive adhesive may be controlled in an automated process to avoid overfilling of the adhesive containment pockets. The filled adhesive containment pockets are shown in FIG. 10D.

In act 414, an adhesive is dispensed onto the liquid crystal cell 40 at its outer periphery, and the baffle 50 is attached to the liquid crystal cell 40 in act 416. As shown in FIG. 10E, the baffle 50 has an opening 52 to admit light to the camera module.

In act 418, the electrical terminals 120, 122, etc. (FIG. 4) of lens mount 30 are electrically connected to the respective terminals 130, 132, etc. of substrate 20 by conductive adhesive or soldering.

Having thus described at least one illustrative embodiment of the invention, various alterations, modifications and improvements will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An electronics module comprising:
a substrate having an electronic circuit mounted thereon;
a lens mount affixed to the substrate, the lens mount having a lens assembly mounted therein; and
a liquid crystal cell affixed to the lens mount over the lens assembly, the liquid crystal cell having electrical terminals, wherein the lens mount includes adhesive containment pockets that are filled with a conductive adhesive so as to contact the electrical terminals of the liquid crystal cell, wherein the adhesive containment pockets include contacts that are electrically connected to the substrate.

2. An electronics module as defined in claim 1, wherein the conductive adhesive fills the adhesive containment pockets to a level below a top surface of the liquid crystal cell.

3. An electronics module as defined in claim 1, wherein the liquid crystal cell comprises two or more glass layers, wherein the electrical terminals of the liquid crystal cell comprise conductive strips between the glass layers, and wherein the conductive adhesive contacts the conductive strips of the liquid crystal cell.

4. An electronics module as defined in claim 3, wherein the liquid crystal cell includes at least two conductive strips associated with each electrical terminal and wherein the adhesive containment pockets have sufficient depth to contact each of the conductive strips.

5. An electronics module as defined in claim 1, wherein the lens mount is provided with an opening for mounting of the liquid crystal cell to the lens assembly.

6. An electronics module as defined in claim 1, wherein each adhesive containment pocket comprises a recess in the lens mount and an electrical contact in the recess.

7. An electronics module as defined in claim 1, wherein the electrical terminals of the liquid crystal cell are located along edges of the liquid crystal cell in alignment with respective adhesive containment pockets.

8. An electronics module as defined in claim 1, wherein electrical connections between the adhesive containment pockets and the substrate are recessed in the lens mount.

9. An electronics module as defined in claim 1, further comprising a baffle mounted over the liquid crystal cell.

10. An electronics module as defined in claim 1, wherein the electronic circuit comprises an image sensor and the electronics module comprises a camera module.

11. A method for making an electronics module, comprising:
providing an electronics subassembly including a substrate having an electronic circuit mounted thereon and a lens mount affixed to the substrate, the lens mount having a lens assembly mounted therein and being provided with adhesive containment pockets;
attaching a liquid crystal cell to the lens mount over the lens assembly; and
filling the adhesive containment pockets with a conductive adhesive so as to contact the electrical terminals of the liquid crystal cell, wherein the adhesive containment pockets include contacts that are electrically connected to the substrate.

12. A method for making an electronics module as defined in claim 11, wherein filling the adhesive containment pockets comprises filling the adhesive containment pockets such that the conductive adhesive fills the adhesive containment pockets to a level below a top surface of the liquid crystal cell.

13. A method for making an electronics module as defined in claim 11, wherein the electrical terminals of the liquid crystal cell comprise conductive strips at an outer periphery of the liquid crystal cell and wherein the adhesive containment pockets are filled so that the conductive adhesive contacts each of the conductive strips.

14. A method for making an electronics module as defined in claim 11, wherein attaching the liquid crystal cell comprises dispensing or stamping an adhesive on a lens barrel of the lens assembly and mounting the liquid crystal cell on the lens assembly.

15. A method for making an electronics module as defined in claim 11, further comprising attaching a baffle to the electronics assembly over the liquid crystal cell.

16. A method for making an electronics module as defined in claim 11, wherein the adhesive containment pockets are molded into the lens mount.

17. A method for making an electronics module as defined in claim 11, wherein the liquid crystal cell includes at least two conductive strips associated with each electrical terminal and wherein the adhesive containment pockets have sufficient depth to contact each of the conductive strips.

18. A method for making an electronics module as defined in claim 11, wherein each adhesive containment pocket comprises a recess in the lens mount and an electrical contact in the recess.

19. A method for making an electronics module as defined in claim 11, wherein the electrical terminals of the liquid crystal cell are located along edges of the liquid crystal cell in alignment with respective adhesive containment pockets.

20. A method for making an electronics module as defined in claim 11, wherein the electronic circuit comprises an image sensor and the electronics module comprises a camera module.
